(19) United States
(12) Patent Application Publication
(10) Pub. No.: US 2019/0390101 A1
(43) Pub. Date: Dec. 26, 2019

(54) HYDRAULIC FRACTURING FLUID

(71) Applicant: Saudi Arabian Oil Company, Dhahran (SA)

(72) Inventors: Leiming Li, Sugar Land, TX (US); Rajesh Kumar Saini, Cypress, TX (US)

(73) Assignee: Saudi Arabian Oil Company, Dhahran (SA)

(21) Appl. No.: 16/017,958

(22) Filed: Jun. 25, 2018

(51) Int. Cl. C09K 8/68; C09K 8/66

(52) U.S. Cl. CPC C09K 8/685; B82Y 30/00; C09K 8/665

(57) ABSTRACT

A fracturing fluid including an aqueous base fluid having total dissolved solids between 100,000 mg/L and 400,000 mg/L, a polymer, a crosslinker, and at least one of a free amine and an alkaline earth oxide. In one example, the fracturing fluid may include a hydroxypropyl guar, a Zr crosslinker, and either a free amine such as triethylamine, or an alkaline earth oxide such as magnesium oxide. Optionally, the fracturing fluid may include a nanomaterial. Suitable example of a nanomaterial includes comprises ZrO₂ nanoparticles. The viscosity and viscosity lifetime of fracturing fluids with polymer, crosslinker, and either a free amine or an alkaline earth oxide are greater than the sum of the effects of the individual components taken separately. This synergistic effect offers significant, practical advantages, including the ability to reduce polymer loading to achieve a desired viscosity, and the ability to achieve better formation cleanup after the fracturing treatment.

### TECHNICAL FIELD

This disclosure relates to high temperature salt water-based fracturing fluids with enhanced stability at high temperatures.

### BACKGROUND

Fracturing fluid is often injected into subterranean reservoirs to hydraulically fracture the reservoir rock. Fracturing fluid is commonly formulated with fresh water. However, fresh water can be costly and difficult to obtain in some production areas. Use of seawater, produced water, brine, or the like with high levels of total dissolved solids (TDS) as a base fluid for hydraulic fracturing can be limited by the instability of the resulting fracturing fluids at elevated temperatures.

### SUMMARY

In one general aspect, the present disclosure provides a fracturing fluid comprising: (i) an aqueous base fluid having total dissolved solids between 100,000 milligram per liter (mg/L) and 400,000 mg/L; (ii) a polymer; (iii) a crosslinker; and (iv) at least one of a free amine and an alkaline earth oxide.

Certain implementations of the general aspect are described later.

In some embodiments, the aqueous base fluid includes total dissolved solids between 200,000 mg/L and 300,000 mg/L.

In some embodiments, the aqueous base fluid includes total dissolved solids of about 300,000 mg/L.

In some embodiments, the alkaline earth oxide includes at least one of calcium oxide and magnesium oxide.

In some embodiments, the fracturing fluid includes from about 0.01% to about 20% by weight, from about 0.02% to about 10% by weight, or from about 0.04% to about 2% by weight of the alkaline earth oxide.

In some embodiments, the free amine includes at least one of triethanolamine, N-methylethanolamine, dimethylethanolamine, diethylethanolamine, diethanolamine, N,N-diisopropylaminoethanol, methyl diethanolamine, bis-tris methane, ethylendiamine, diethylenetriamine, triethylenetetramine, tetraethylenepentamine, and pentaethylenehexamine.

In some embodiments, the fracturing fluid includes between about 0.01% and about 20% by weight, between about 0.05% and about 5% by weight, or between about 0.1% and about 2% by weight of the free amine.

In some embodiments, the crosslinker includes a Zr crosslinker, a Ti crosslinker, an Al crosslinker, a borate crosslinker, or a combination thereof.

In some embodiments, the fracturing fluid includes from about 0.02% to about 2% by weight of the crosslinker.

In some embodiments, the fracturing fluid also includes a nanomaterial.

In some embodiments, the nanomaterial includes ZrO₂ nanoparticles, TiO₂ nanoparticles, CeO₂ nanoparticles, or a combination thereof.

In some embodiments, the nanomaterial is stabilized with a polymer, a surfactant, or a combination thereof. When nanomaterial in stabilized with a polymer, the nanoparticles of the nanomaterial do not aggregate or agglomerate.

In some embodiments, the fracturing fluid includes from about 0.0002 wt. % to about 2 wt. % of the nanomaterial.

In some embodiments, the polymer includes guar, hydroxypropyl guar, carboxymethyl hydroxypropyl guar, derivatized guar, carboxymethyl cellulose, carboxtmethyl hydroxyl propyl cellulose, cellulose derivatives, or a combination thereof.

In some embodiments, the fracturing fluid also includes a bactericide.

In some embodiments, the fracturing fluid also includes a buffer, and the buffer includes bicarbonate, carbonate, acetate, or a combination thereof.

In some embodiments, the fracturing fluid also includes a stabilizer, and the stabilizer comprises sodium thiosulfate, sorbitol, alkylated sorbitol, or a combination thereof.

In some embodiments, the fracturing fluid also includes a viscosity breaker, and the viscosity breaker includes an oxidative breaker.

In some embodiments, the fracturing fluid also includes a surfactant.

In some embodiments, the fracturing fluid also includes a scale inhibitor.

The viscosity and viscosity lifetime of fracturing fluids at elevated temperatures can be enhanced with an amine additive, an alkaline earth oxide additive, or both. These additives, separately or together, offer significant, practical advantages, including the ability to use high total dissolved solids (TDS) produced water rather than fresh or salt water, the ability to reduce polymer loading to achieve a desired viscosity, and the ability to achieve better formation cleanup after the fracturing treatment.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts delivery of a fracturing fluid to a subterranean formation.

FIG. 2 shows plots of viscosity versus time for the fracturing fluids of Example 1.

FIG. 3 shows plots of viscosity versus time for the fracturing fluids of Example 2.

FIG. 4 shows plots of viscosity versus time for the fracturing fluids of Example 3.

FIG. 5 shows plots of viscosity versus time for the fracturing fluids of Example 4.

FIG. 6 shows plots of viscosity versus time for the fracturing fluids of Example 5.

FIG. 7 shows plots of viscosity versus time for the fracturing fluids of Example 6.

FIG. 8 shows plots of viscosity versus time for the fracturing fluids of Example 7.

FIG. 9 shows plots of viscosity versus time for the fracturing fluids of Example 8.

FIG. 10 shows plots of viscosity versus time for the fracturing fluids of Example 9.

### DETAILED DESCRIPTION

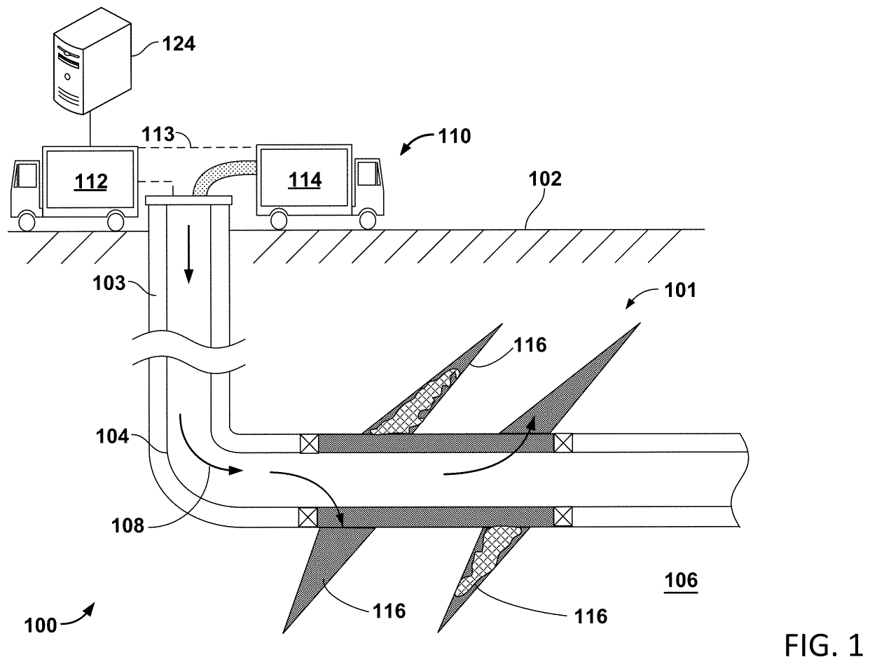

FIG. 1 depicts an example well system 100 for applying a fracture treatment to a subterranean formation 101. Fracture treatments can be used, for example, to form or propagate fractures in a rock layer by injecting pressurized fluid. The fracture treatment can include an acid treatment to enhance or otherwise influence production of petroleum, natural gas, coal seam gas, or other types of reservoir resources. The example well system 100 includes an injection system 110 that applies fracturing fluid 108 to a reservoir 106 in the subterranean zone 101. The subterranean zone 101 can include a formation, multiple formations, or portions of a formation. The injection system 110 includes control trucks 112, pump trucks 114, a wellbore 103, a working string 104, and other equipment. In the example shown in FIG. 1, the pump trucks 114, the control trucks 112, and other related equipment are above the surface 102, and the wellbore 103, the working string 104, and other equipment are beneath the surface 102. An injection system can be configured as shown in FIG. 1 or in a different manner, and it can include additional or different features as appropriate. The injection system 110 can be deployed in any suitable environment, for example, by skid equipment, a marine vessel, sub-sea deployed equipment, or other types of equipment.

The wellbore 103 shown in FIG. 1 includes vertical and horizontal sections. Generally, a wellbore can include horizontal, vertical, slant, curved, and other types of wellbore geometries and orientations, and the acid treatment can generally be applied to any portion of a subterranean zone 101. The wellbore 103 can include a casing that is cemented or otherwise secured to the wellbore wall. The wellbore 103 can be uncased or include uncased sections. Perforations can be formed in the casing to allow fracturing fluids or other materials to flow into the reservoir 106. Perforations can be formed using shape charges, a perforating gun, or other tools.

The pump trucks 114 can include mobile vehicles, immobile installations, skids, hoses, tubes, fluid tanks or reservoirs, pumps, valves, or other suitable structures and equipment. The pump trucks 114 can communicate with the control trucks 112, for example, by a communication link 113. The pump trucks 114 are coupled to the working string 104 to communicate the fracturing fluid 108 into the wellbore 103. The working string 104 can include coiled tubing, sectioned pipe, or other structures that communicate fluid through the wellbore 103. The working string 104 can include flow control devices, bypass valves, ports, and or other tools or well devices that control the flow of fracturing fluid from the interior of the working string 104 into the reservoir 106.

Fracturing fluid 108 includes a base fluid and one or more polymers, crosslinkers, and nanomaterials. Fracturing fluid 108 may also include one or more buffers, stabilizers, and viscosity breakers. In some cases, fracturing fluid 108 include one or more other additives.

Base fluid in fracturing fluid 108 includes salt water. As describe in this application, “salt water” generally refers to water including dissolved salts such as sodium chloride, such as seawater (for example, untreated seawater), produced water, brine, brackish water, and the like. The base fluid is typically high in total dissolved solids (TDS). TDS in the base fluid may be in a range from about 500 milligrams per liter (mg/L) to over 300,000 mg/L. In some examples, TDS in the base fluid is in a range between 100,000 mg/L and 400,000 mg/L, between 150,000 mg/L and 350,000 mg/L, between 200,000 mg/L and 300,000 mg/L, or about 300,000 mg/L. An acidic pH adjusting agent such as acetic acid or diluted hydrogen chloride (HCl) may be used to adjust the pH of the base fluid to a pH of less than about 7, more particularly, to a pH of less than about 6, during, for example, the hydration of polymers. In some cases, a basic pH adjusting agent including one or more amines such as triethanolamine, N-methylethanolamine, dimethylethanolamine, diethylethanolamine, diethanolamine, N,N-diisopropylaminoethanol, methyldiethanolamine, bis-tris methane, ethylendiamine, diethylenetriamine, triethylenetetramine, tetraethylenepentamine, pentaethylenehexamine, and the like, may be used to increase the pH of the base fluid up to about 6 or about 7, thereby delaying crosslinking of the fracturing fluid relative to a fracturing fluid with a lower pH, and also enhancing the fluid stability at elevated temperatures. These amines, referred to as “free amines,” are not complexed as ligands to a metal. In some examples, the concentration of the added amines is in the range from about 0.01% to about 20% by weight, from about 0.05% to about 5% by weight, or from about 0.1% to about 2% by weight of the fracturing fluid.

Polymers suitable for fracturing fluid 108 include polysaccharides such as hydroxypropyl guar (HPG), carboxymethylhydroxypropyl guar (CMHPG), guar, carboxymethyl guar (CMG), derivatized guar, carboxymethyl cellulose, carboxtmethyl hydroxyl propyl cellulose, cellulose derivatives, hydrophobically modified guars, guar-containing compounds, and artificially modified polymers, and other polymers generally known in the art to be suitable for fracturing fluids. The polymer may be in the form of a slurry. Slurries can be made by dispersions of dry polymer particles in solvents such as mineral oil with a suspending aid such as modified clay. Fracturing fluid 108 typically includes about 5 pounds per thousand gallons of fracturing fluid (ppt) to about 100 ppt of one or more such polymers.

The term “derivative” or “derivatized” as used in this application refers to a chemically modified compound, for examples, by alkylation, esterification, amination, or ethoxylation. In one example, ethoxylated derivative of a compound includes the PEGylated compound.

Crosslinkers suitable for fracturing fluid 108 include zirconium (Zr) crosslinkers, typically having a ZrO₂ content of about 4 weight percent (wt. %) to about 14 wt. % or more. Fracturing fluid 108 typically includes about 0.1 gallons per thousand gallons of fracturing fluid (gpt) to about 10 gpt of one or more such crosslinkers. Suitable zirconium crosslinkers include by non-limiting example, zirconium lactates (such as sodium zirconium lactate), zirconium triethanolamines, zirconium 2,2′-iminodiethanol, and mixtures of these ligands bound to the zirconium. Crosslinkers suitable for fracturing fluid may also include titanium (Ti) crosslinkers. Suitable titanate crosslinkers include by non-limiting example, titanate crosslinkers with ligands such as lactates and triethanolamines, and mixtures of these ligands bound to the titanium, and optionally delayed with hydroxyacetic acid. Crosslinkers suitable for fracturing fluid may also include borate crosslinkers, aluminum (Al) crosslinkers, chromium (Cr) crosslinkers, iron (Fe) crosslinkers, and hafnium (Hf) crosslinkers.

Buffers suitable for fracturing fluid 108 include bicarbonate (such as NaHCO₃), carbonate (such as Na₂CO₃), phosphate, hydroxide, acetate, and formate.

Stabilizers suitable for fracturing fluid 108 include sodium thiosulfate (Na₂S₂O₃ or Na₂S₂O₃.5H₂O), sorbitol, and commercially available alkylated sorbitol. Other stabilizers include alkaline earth metal oxides (for example, calcium oxide (CaO) and magnesium oxide (MgO)). In some examples, the concentration of an alkaline earth metal oxide in the fluid is in the range from about 0.01% to about 20% by weight, from about 0.02% to about 10% by weight, or from about 0.04% to about 2% by weight. One or more of these stabilizers may be used with one or more of the amines described previously. These stabilizer or alkaline earth metal oxides are used in the concentration enough to take the pH between 4.5-7.0.

Nanomaterials suitable for fracturing fluid 108 include ZrO₂, TiO₂, and CeO₂ nanoparticles; polyvinylpyrrolidone (PVP)-stabilized ZrO₂, TiO₂, and CeO₂ nanoparticles, carbon nanomaterials (such as carbon nanorods, carbon nanotubes, carbon nanodots, nano graphene, nano graphene oxide, and the like); Zr, Ti, and Ce nanoparticles and other metal nanoparticles; metal-organic polyhedra including Zr, Ti, or Ce, and other metals. Here, “metal-organic polyhedra” refer to a hybrid class of solid-state crystalline materials constructed from the in-situ assembly of highly modular pre-designed molecular building blocks (MBBs) into discrete architectures (0-D) containing a cluster of multi-valent metal nodes. Suitable nanomaterials may have a dimension in a range between about 0.1 nanometers (nm) and about 1000 nm. The nanomaterials may be added as solutions in which the nanoparticles are suspended and stabilized with surfactants, polymers like polyvinylpyrrolidone, or both. Fracturing fluid 108 typically includes about 0.0002 wt. % to 2 wt. % of fluid of one or more such nanomaterials. In some cases, the nanomaterials and the crosslinkers include a common metal (for example, Zr or Ti).

Viscosity breakers suitable for fracturing fluid 108 include oxidative breakers such as persulfate (for example, sodium persulfate), bromate (for example, sodium bromate). Fracturing fluid 108 typically includes one or more such viscosity breakers and related encapsulated breakers.

Additives suitable for fracturing fluid 108 also include surfactants, scale inhibitors, clay stabilizers, and the like, depending on the specific requirements of oilfield operations. A surfactant present in fracturing fluid 108 acts as a surface active agent and may function as an emulsifier, dispersant, oil-wetter, water-wetter, foamer, or defoamer. Suitable examples of surfactants include, but are not limited to fatty alcohols, cetyl alcohol, stearyl alcohol, and cetostearyl alcohol. Fracturing fluid 108 may incorporate a surfactant or blend of surfactants in an amount between about 0.01 wt. % and about 5 wt. % of total fluid weight.

The fracturing fluid of the present disclosure may optionally include other chemically different materials. In embodiments, the fluid may further include different stabilizing agents, surfactants, diverting agents, proppant, clay stabilizers, gel stabilizers, bactericides, or other additives.

The combined presence of crosslinkers and nanomaterials in fracturing fluid 108 enhances the fluid viscosity of the fracturing fluid at temperatures of about 270° F. to about 300° F. and above, with the fracturing fluid demonstrating a higher viscosity and a longer lifetime than would be expected based on the properties of fracturing fluids with crosslinkers or nanomaterials only. That is, the viscosity and viscosity lifetime of fracturing fluid 108 with both crosslinkers and nanomaterials are greater than the sum of the effects of crosslinkers and nanomaterials taken separately. The synergistic effect can be increased by the addition of one or more additives including free amines not binding to crosslinking metal, alkaline earth metal oxides, or borates, as described previously. Moreover, this synergistic effect offers significant, practical advantages, including the ability to use salt water and high TDS water rather than fresh water for fracturing fluids, the ability to reduce polymer loading to achieve a desired viscosity, and the ability to achieve better formation cleanup after the fracturing treatment.

The control trucks 112 can include mobile vehicles, immobile installations, or other suitable structures. The control trucks 112 can control or monitor the injection treatment. For example, the control trucks 112 can include communication links that allow the control trucks 112 to communicate with tools, sensors, or other devices installed in the wellbore 103. The control trucks 112 can receive data from, or otherwise communicate with, a computing system 124 that monitors one or more aspects of the acid treatment.

In addition, the control trucks 112 can include communication links that allow the control trucks 112 to communicate with the pump trucks 114 or other systems. The control trucks 112 can include an injection control system that controls the flow of the fracturing fluid 108 into the reservoir 106. For example, the control trucks 112 can monitor or control the concentration, density, volume, flow rate, flow pressure, location, proppant, or other properties of the fracturing fluid 108 injected into the reservoir 106. The reservoir 106 can include a fracture network with multiple fractures 116, as shown in FIG. 1

The features described can be implemented in digital electronic circuitry, or in computer hardware, firmware, software, or in combinations of them. The apparatus can be implemented in a computer program product tangibly embodied in an information carrier, for example, in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. The processor and the memory can be supplemented by, or incorporated in, application-specific integrated circuits (ASICs).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a local area network (LAN), a wide area network (WAN), and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the described logic flows do not require the particular order shown, or sequential order, to achieve desirable results. In addition, other steps may be provided, or steps may be eliminated, from the described flows, and other components may be added to, or removed from, the described systems.

### EXAMPLES

The following examples are put forth so as to provide those of ordinary skill in the art with a complete disclosure and description of how the disclosed compositions are made and evaluated, and are intended to be purely exemplary and are not intended to be limiting in scope. Efforts have been made to ensure accuracy with respect to numbers (for example, amounts, temperature, and the like), but some errors and deviations should be accounted for.

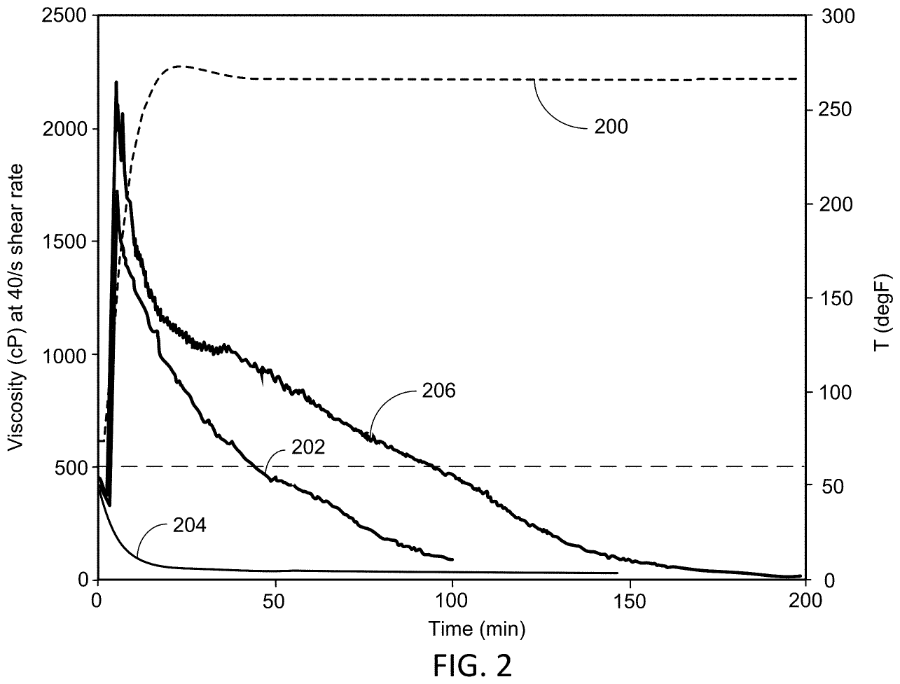

Examples 1-6 provide exemplary fracturing fluids prepared in untreated seawater and including a crosslinker and metal oxide nanoparticles. Comparative examples include fracturing fluids prepared in untreated seawater with a crosslinker or metal oxide nanoparticles, but not both. Fracturing fluids were prepared using a blender (for example, a WARING blender). The polymer was hydrated in the seawater first to form a base fluid. Additives (for example, buffer and stabilizer) were added to the base fluid followed by the addition of nanomaterial and the crosslinker. FIGS. 2-7 show plots of viscosity in centipoise (cP) at 40/second (sec⁻¹) shear rate over time for the fracturing fluids at the temperature shown by plots 200, 300, 400, 500, 600, and 700, respectively. Viscosity of the fracturing fluids was measured at a shear rate of 40 sec⁻¹ at selected temperatures with a Fann 50-type High-Pressure, High-Temperature (HPHT) viscometer (for example, a Grace M5600 HPHT Rheometer).

Example 8 provides exemplary fracturing fluid prepared in TDS water including polymer, crosslinker, HPG, organic Zr crosslinker, and triethanolamine. The exemplified fracturing fluid possessed enhanced stability and viscosity as compared to fluid prepared without triethanolamine but having otherwise identical composition.

Example 9 provides exemplary fracturing fluid prepared in TDS water including polymer, crosslinker, HPG, organic Zr crosslinker, and MgO. The exemplified fracturing fluid possessed enhanced stability and viscosity as compared to fluid prepared without MgO but having otherwise identical composition.

Untreated seawater (TDS of about 57,000 mg/L) was used to prepare the fracturing fluids in Examples 1-6. The ZrO₂ nanoparticle solution (20 wt. %, 45-55 nanometers (nm)), TiO₂ nanoparticle solution (rutile, 15 wt. %, 5-15 nm), and CeO₂ nanoparticle solution (20 wt. %, 30-50 nm) were commercially available products, and used as received without further treatment. The Zr crosslinkers, the HPG slurry, and the sorbitol derivative are all commercially available.

### Example 1

Comparative Fracturing Fluids 1A and 1B (CFF1A and CFF1B, respectively) and Fracturing Fluid 1 (FF1) were prepared as shown in Table 1. CFF1A was prepared with seawater (TDS of about 57,000 mg/L), 60 ppt HPG slurry (that is, containing 60 pounds per thousand gallons (ppt) of dried HPG), 2 ppt NaHCO₃, 10 ppt Na₂S₂O₃.5H₂O, 10 ppt sorbitol, and crosslinked with 5 gallons per thousand gallons (gpt) of the Zr crosslinker (type 1). Plot 200 in FIG. 2 shows the temperature (° F.) at which viscosity measurements were made. Plot 202 shows the viscosity of CFF1A at 270° F. The fluid viscosity stayed above 500 cP for about 44 minutes. CFF1B was prepared with seawater, 60 ppt HPG slurry, 2 ppt NaHCO₃, 10 ppt Na₂S₂O₃.5H₂O, 10 ppt sorbitol, and 1 gpt of the ZrO₂ nanoparticle solution. No Zr crosslinker was present in CFF1B. As shown in plot 204, the viscosity of CFF1B at 270° F. decreased rapidly and never reached 500 cP. FF1 was prepared with seawater, 60 ppt HPG slurry, 2 ppt NaHCO₃, 10 ppt Na₂S₂O₃.5H₂O, 10 ppt sorbitol, 1 gpt of the ZrO₂ nanoparticle solution, and 5 gpt of the Zr crosslinker (type 1). As shown in plot 206, the viscosity of FF1 at 270° F. stayed above 500 cP for about 95 minutes. FF1 demonstrated a longer lifetime (for example, length of time with a viscosity above 500 cP), and the viscosity of FF1 was higher than that of CFF1A and CFF1B combined at elapsed times exceeding about 20 minutes, indicating that the Zr crosslinker and the ZrO₂ nanoparticles in FF1 worked synergically to enhance the fluid viscosity of FF1.

TABLE 1
Example 1: Fracturing fluid with Zr
crosslinker and ZrO₂ nanoparticles.

| | Component | | |
|---|---|---|---|
| Seawater (TDS 57,000 mg/L) | CFF1A | CFF1B | FF1 |
| HPG slurry (ppt) | 60 | 60 | 60 |
| NaHCO₃ (ppt) | 2 | 2 | 2 |
| Na₂S₂O₃•5H₂O (ppt) | 10 | 10 | 10 |
| Sorbitol (ppt) | 10 | 10 | 10 |
| Zr crosslinker (gpt) | 5 | | 5 |
| ZrO₂ nanoparticle solution (gpt) | | 1 | 1 |

### Example 2

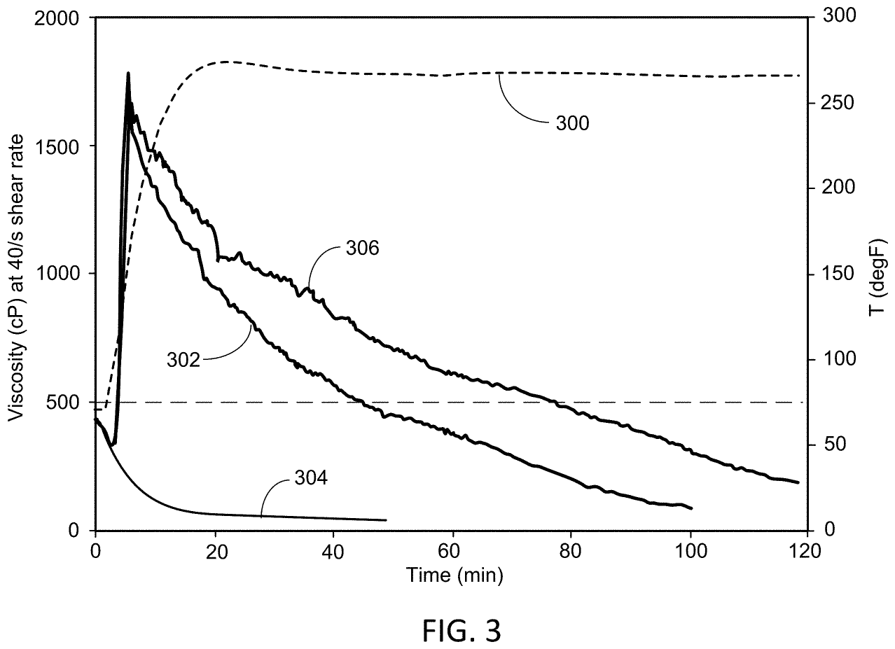

Comparative Fracturing Fluids 2A and 2B (CFF2A and CFF2B, respectively) and Fracturing Fluid 2 (FF2) were prepared as shown in Table 2. CFF2A was prepared with seawater (TDS of about 57,000 mg/L), 60 ppt HPG slurry, 2 ppt NaHCO₃, 10 ppt Na₂S₂O₃.5H₂O, 10 ppt sorbitol, and crosslinked with 5 gpt of Zr crosslinker (type 1). Plot 300 in FIG. 3 shows the temperature (° F.) at which viscosity measurements were made. As shown in plot 302, the fluid viscosity of CFF2A stayed above 500 cP for about 44 minutes. CFF2B was prepared with seawater, 60 ppt HPG slurry, 2 ppt NaHCO₃, 10 ppt Na₂S₂O₃.5H₂O, 10 ppt sorbitol, and 1 gpt of the TiO₂ nanoparticle solution. No Zr crosslinker was present in CFF2B. As shown in plot 304, the viscosity of CFF2B at 270° F. decreased rapidly and never reached 500 cP. FF2 was prepared with seawater, 60 ppt HPG slurry, 2 ppt NaHCO₃, 10 ppt Na₂S₂O₃.5H₂O, 10 ppt sorbitol, 1 gpt of the TiO₂ nanoparticle solution, and 5 gpt of the Zr crosslinker (type 1). As shown in plot 306, the viscosity of FF2 at 270° F. stayed above 500 cP for about 78 minutes. FF2 demonstrated a longer lifetime (for example, length of time with a viscosity above 500 cP), and the viscosity of FF2 was higher than that of CFF2A and CFF2B combined at elapsed times exceeding about 20 minutes, indicating that the Zr crosslinker and the nano TiO₂ in FF2 worked synergically to enhance the fluid viscosity of FF2.

TABLE 2
Example 2: Fracturing fluid with Zr
crosslinker and TiO₂ nanoparticles.

| | Component | | |
|---|---|---|---|
| Seawater (TDS 57,000 mg/L) | CFF2A | CFF2B | FF2 |
| HPG slurry (ppt) | 60 | 60 | 60 |
| NaHCO₃ (ppt) | 2 | 2 | 2 |
| Na₂S₂O₃•5H₂O (ppt) | 10 | 10 | 10 |
| Sorbitol (ppt) | 10 | 10 | 10 |
| Zr crosslinker (gpt) | 5 | | 5 |
| TiO₂ nanoparticle solution (gpt) | | 1 | 1 |

### Example 3

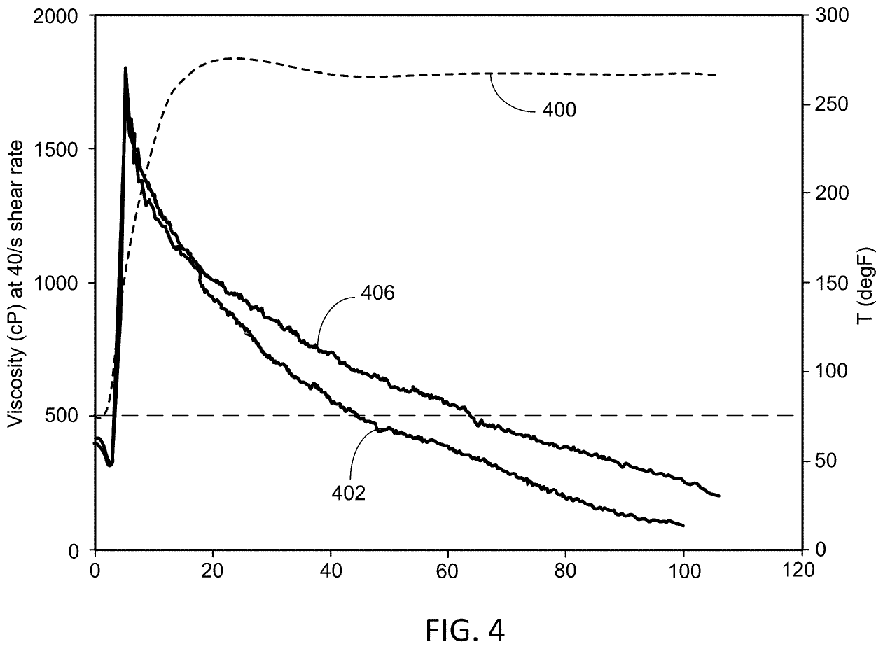

Comparative Fracturing Fluids 3A and 3B (CFF3A and CFF3B, respectively) and Fracturing Fluid 3 (FF3) were prepared as shown in Table 3. CFF3A was prepared with seawater, 60 ppt HPG slurry, 2 ppt NaHCO₃, 10 ppt Na₂S₂O₃.5H₂O, 10 ppt sorbitol, and crosslinked with 5 gpt of the Zr crosslinker (type 1). Plot 400 in FIG. 4 shows the temperature (° F.) at which viscosity measurements were made. As shown in plot 402, the fluid viscosity of CFF3A stayed above 500 cP for about 44 minutes. FF3 was prepared with seawater, 60 ppt HPG slurry, 2 ppt NaHCO₃, 10 ppt Na₂S₂O₃.5H₂O, 10 ppt sorbitol, 1 gpt of the CeO₂ nanoparticle solution, and 5 gpt of the Zr crosslinker (type 1). As shown in plot 406, the viscosity of FF3 at 270° F. stayed above 500 cP for about 64 minutes. FF3 demonstrated a longer lifetime (for example, length of time with a viscosity above 500 cP) than CFF3A, and the viscosity of FF3 was higher than that of CFF3A at elapsed times exceeding about 20 minutes. CFF3B was prepared with seawater, 60 ppt HPG slurry, 2 ppt NaHCO₃, 10 ppt Na₂S₂O₃, .5H₂O, and 10 ppt sorbitol; 1 gpt of the CeO₂ nanoparticle solution was then added. The Zr crosslinker was not used. The viscosity of the fluid (not shown) at 270° F. quickly dropped below 500 cP within minutes. This suggests that the Zr crosslinker and the CeO₂ nanoparticles worked synergically to enhance the fluid viscosity.

able 3. Example 3: Fracturing fluid with Zr crosslinker and CeO₂ nanoparticles.

| | Component | | |
|---|---|---|---|
| Seawater (TDS 57,000 mg/L) | CFF3A | CFF3B | FF3 |
| HPG slurry (ppt) | 60 | 60 | 60 |
| NaHCO₃ (ppt) | 2 | 2 | 2 |
| Na₂S₂O₃•5H₂O (ppt) | 10 | 10 | 10 |
| Sorbitol (ppt) | 10 | 10 | 10 |
| Zr crosslinker (gpt) | 5 | | 5 |
| CeO₂ nanoparticle solution (gpt) | | 1 | 1 |

### Example 4

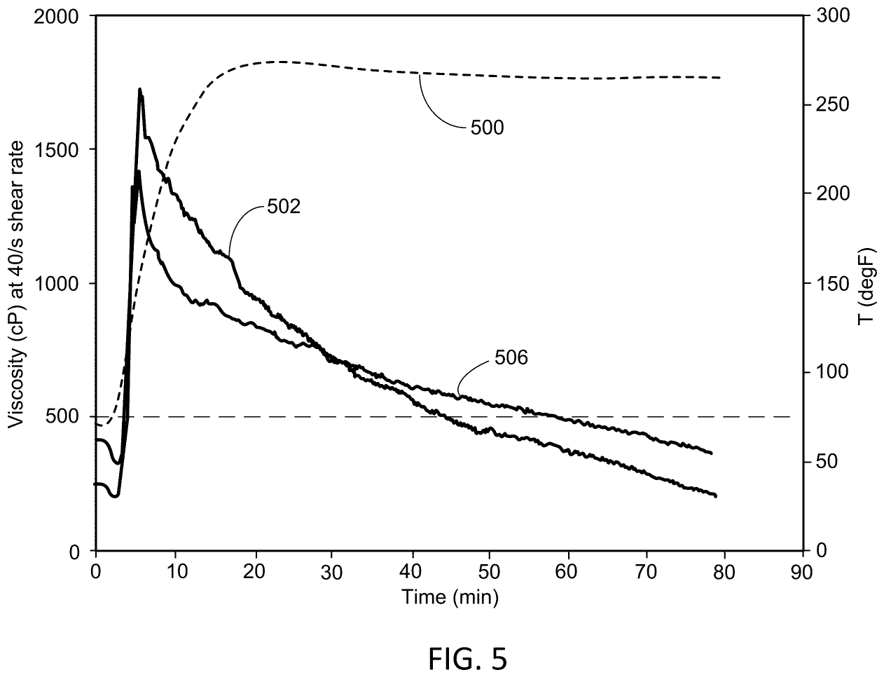

Comparative Fracturing Fluid 4A (CFF4A) and Fracturing Fluid 4 (FF4) were prepared as shown in Table 4. CFF4A was prepared with seawater, 60 ppt HPG slurry, 2 ppt NaHCO₃, 10 ppt Na₂S₂O₃.5H₂O, 10 ppt sorbitol, and crosslinked with 5 gpt of the Zr crosslinker (type 1). Plot 500 in FIG. 5 shows the temperature (° F.) at which viscosity measurements were made. As shown in plot 502, the fluid viscosity of CFF4A stayed above 500 cP for about 44 minutes. FF4 was prepared with seawater, 50 ppt HPG slurry, 2 ppt NaHCO₃, 10 ppt Na₂S₂O₃.5H₂O, 10 ppt sorbitol, 1 gpt of the ZrO₂ nanoparticle solution, and 5 gpt of the Zr crosslinker (type 1). As shown in plot 506, the viscosity of FF4 at 270° F. stayed above 500 cP for about 59 minutes. Even with 50 ppt of the polymer loading, FF4 showed a longer lifetime than CFF4A with 60 ppt of the polymer. Thus, the addition of 1 gpt of the ZrO₂ nanoparticle solution appears to compensate for a lower polymer content without sacrificing the fluid performance at high temperatures. Reduced polymer loading usually translates into better formation cleanup after the fracturing treatment.

TABLE 4
Example 4: Fracturing fluid with Zr
crosslinker and ZrO₂ nanoparticles.

Component

| Seawater (TDS 57,000 mg/L) | CFF4A | FF4 |
|---|---|---|
| HPG slurry (ppt) | 60 | 50 |
| NaHCO₃ (ppt) | 2 | 2 |
| Na₂S₂O₃•5H₂O (ppt) | 10 | 10 |
| Sorbitol (ppt) | 10 | 10 |
| Zr crosslinker (ppt) | 5 | 5 |
| ZrO₂ nanoparticle solution (gpt) | | 1 |

### Example 5

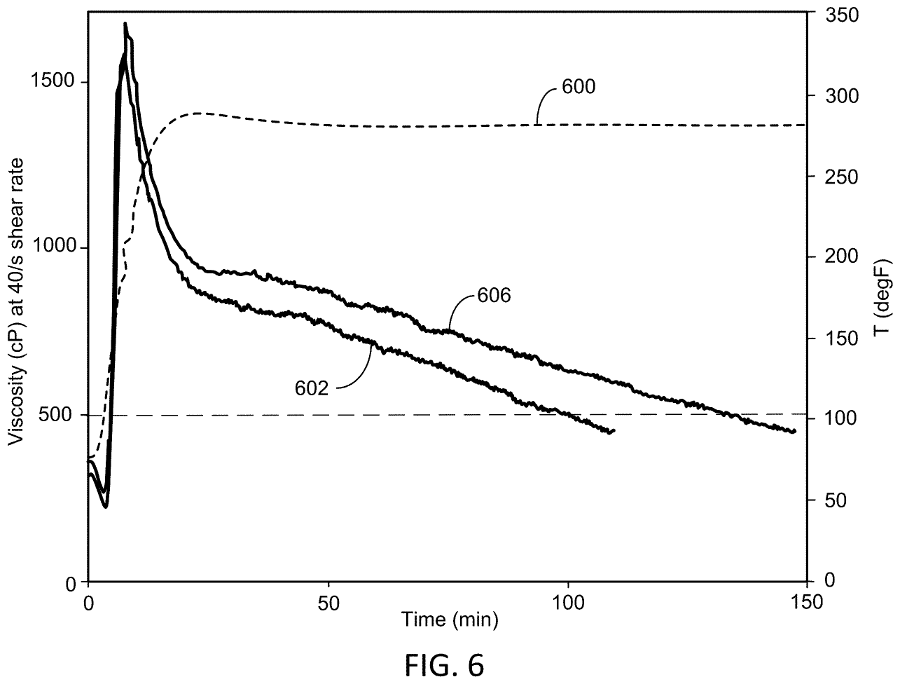

Comparative Fracturing Fluids 5A and 5B (CFF5A and CFF5B, respectively) and Fracturing Fluid 5 (FF5) were prepared as shown in Table 5. CFF5A was prepared with seawater, 54 ppt HPG slurry, 2 ppt NaHCO₃, 10 ppt Na₂S₂O₃.5H₂O, 5 gpt of commercially available alkylated sorbitol, and crosslinked with 2.8 gpt of Zr crosslinker (type 2, pH adjusted to about 6.0). No nanoparticle solution was added to CFF5A. Plot 600 in FIG. 6 shows the temperature (° F.) at which viscosity measurements were made. As shown in plot 602, the fluid viscosity of CFF5A at 285° F. stayed above 500 cP for about 100 minutes. FF5 was prepared with seawater, 54 ppt HPG slurry, 2 ppt NaHCO₃, 10 ppt Na₂S₂O₃.5H₂O, 5 gpt of the alkylated sorbitol, 0.5 gpt of the ZrO₂ nanoparticle solution, and 2.8 gpt of the Zr crosslinker (Type 2, pH adjusted to about 6.0). As shown in plot 606, the viscosity of FF5 at 285° F. stayed above 500 cP for about 134 minutes. With the same polymer loading, FF5 showed longer lifetime than CFF5A due to the addition of 0.5 gpt of the nano ZrO₂ solution. CFFSB was prepared with seawater, 54 ppt HPG slurry, 2 ppt NaHCO₃, 10 ppt Na₂S₂O₃.5H₂O, and 5 gpt the alkylated sorbitol; 0.5 gpt of the ZrO₂ nanoparticle solution was then added. The Zr crosslinker was not used. The viscosity of the fluid (not shown) at 285° F. quickly dropped below 500 cP within minutes. This again suggests that the Zr crosslinker and the nano ZrO₂ worked synergically to enhance the fluid viscosity.

TABLE 5
Example 5: Fracturing fluid with Zr
crosslinker and ZrO₂ nanoparticles.

| | Component | | |
|---|---|---|---|
| Seawater (TDS 57,000 mg/L) | CFF5A | CFF5B | FF5 |
| HPG slurry (ppt) | 54 | 54 | 54 |
| NaHCO₃ (ppt) | 2 | 2 | 2 |
| Na₂S₂O₃•5H₂O (ppt) | 10 | 10 | 10 |
| alkylated sorbitol (gpt) | 5 | 5 | 5 |
| Zr crosslinker, type 2 (gpt) | 2.8 | | 2.8 |
| ZrO₂ nanoparticle solution (gpt) | | 0.5 | 0.5 |

### Example 6

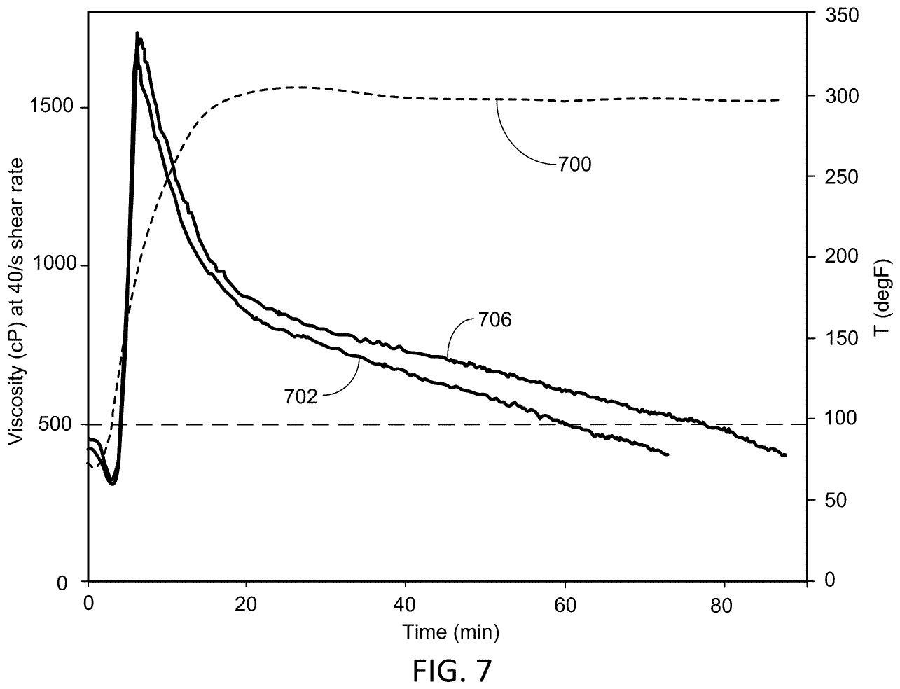

Comparative Fracturing Fluids 6A and 6B (CFF6A and CFF6B, respectively) and Fracturing Fluid 6 (FF6) were prepared as shown in Table 6. CFF6A was prepared with seawater, 60 ppt HPG slurry, 4 ppt NaHCO₃, 10 ppt Na₂S₂O₃.5H₂O, 5 gpt commercially available alkylated sorbitol, and crosslinked with 2.8 gpt of the Zr crosslinker (Type 2, pH adjusted to about 6.0). No nanoparticle solution was added to CFF6A. Plot 700 in FIG. 7 shows the temperature (° F.) at which viscosity measurements were made. As shown in plot 702, the fluid viscosity of CFF6A at 300° F. stayed above 500 cP for about 60 minutes. FF6 was prepared with seawater, 60 ppt HPG slurry, 4 ppt NaHCO₃, 10 ppt Na₂S₂O₃.5H₂O, 5 gpt of the alkylated sorbitol, 1 gpt of the ZrO₂ nanoparticle solution, and 2.8 gpt of the Zr crosslinker (Type 2, pH adjusted to about 6.0). As shown in plot 706, the viscosity of FF6 at 300° F. stayed above 500 cP for about 78 minutes. With the same polymer loading, FF6 showed a longer lifetime than CFF6A due to the addition of 1 gpt of the ZrO₂ nanoparticle solution. CFF6B was prepared with seawater, 60 ppt HPG slurry, 4 ppt NaHCO₃, 10 ppt Na₂S₂O₃.5H₂O, and 5 gpt of the alkylated sorbitol; 1 gpt of the ZrO₂ nanoparticle solution was then added. The Zr crosslinker was not used. The viscosity of the fluid (not shown) at 300° F. quickly dropped below 500 cP within minutes. This again suggests that the Zr crosslinker and the ZrO₂ nanoparticles worked synergically to enhance the fluid viscosity.

TABLE 6
Example 6: Fracturing fluid with Zr
crosslinker and ZrO₂ nanoparticles.

| | Component | | |
|---|---|---|---|
| Seawater (TDS 57,000 mg/L) | CFF6A | CFF6B | FF6 |
| HPG slurry (ppt) | 60 | 60 | 60 |
| NaHCO₃ (ppt) | 4 | 4 | 4 |
| Na₂S₂O₃•5H₂O (ppt) | 10 | 10 | 10 |
| alkylated sorbitol (gpt) | 5 | 5 | 5 |
| Zr crosslinker, type 2 (gpt) | 2.8 | | 2.8 |
| Nano TiO₂ solution (gpt) | | 1 | 1 |

By way of summary, Table 7 shows the length of time the various fracturing fluids and comparative fracturing fluids (FFX, CFFXA, and CFFXB, where X corresponds to Example X) in Examples 1-6 maintained a viscosity above 500 cP at the elevated temperature disclosed with respect to each example. As discussed above with respect to Examples 1-6, these results demonstrate that presence of the nanoparticles has a greater than additive effect on the viscosity of the fracturing fluid at elevated temperatures. This synergistic effect is significant in that available water sources with high levels of total dissolved solids can be used to prepare fracturing fluids having a viscosity sufficient for use at elevated temperatures of at least 270° F. (for example, 270° F. to 300° F.). In addition, the synergistic effect allows for longer lifetimes for equivalent polymer loading, as well as longer lifetimes for lower polymer loadings.

TABLE 7
Length of time in minutes (min) viscosity
exceeds 500 cP at elevated temperature.

| Example X | CFFXA (min) | CFFXB (min) | FFX (min) |
|---|---|---|---|
| Example 1 | 44 | 0 | 95 |
| Example 2 | 44 | 0 | 78 |
| Example 3 | 44 | 0 | 64 |
| Example 4 | 44 | | 59 |
| Example 5 | 100 | | 134 |
| Example 6 | 60 | | 78 |

### Example 7

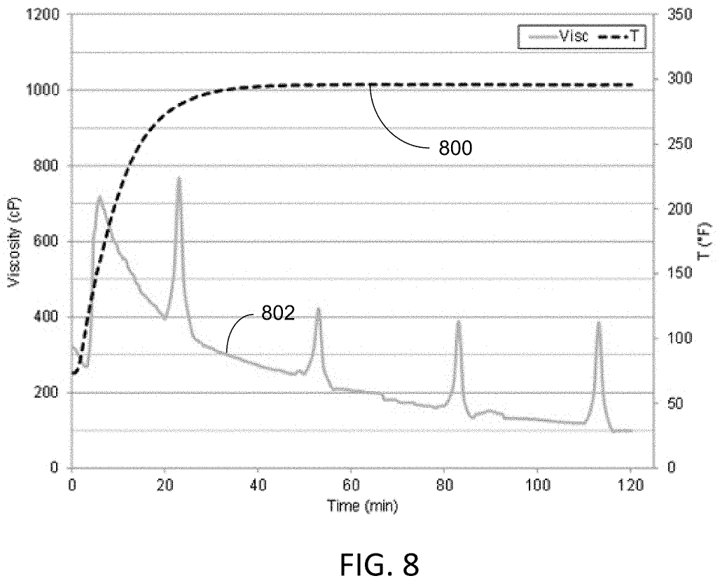

Comparative fracturing fluid CFF7 (no nanoparticle solution) was prepared with seawater having the composition shown in Table 8, 60 ppt HPG, and 2.8 gpt TYZOR 212 organic zirconate crosslinker (available from Dorf Ketal). The seawater had a TDS of 56,800 mg/L, a total hardness of 10,200 mg/L, and a pH of 8.1. A pH of CFF7 was between 6 and 7 at room temperature. CFF7 maintained a viscosity above 100 cP for over 2 hours at 300° F. Plot 800 in FIG. 8 shows the temperature (° F.) at which viscosity measurements were made, and plot 802 shows the fluid viscosity of CFF7 versus time. In FIG. 8, the viscosity was measured following the API RP 39 schedule. The API RP 39 schedule consists of continuous fluid shearing at 100/s shear rate and a series of shearing ramps at 100, 75, 50, 25, 50, 75, and 100/s once the fluid temperature is within 5° F. of the test temperature and occurring periodically for every 30 minutes.

TABLE 8
Water analysis of seawater used in Example 7.

| Component | Concentration | |
|---|---|---|
| Boron | <1 | mg/L |
| Barium | <1 | mg/L |
| Calcium | 618 | mg/L |
| Iron | <1 | mg/L |
| Magnesium | 2,108 | mg/L |
| Potassium | 595 | mg/L |
| Silicon | <1 | mg/L |
| Sodium | 18,451 | mg/L |
| Strontium | 11 | mg/L |
| Chloride | 30,694 | mg/L |
| Sulfate | 4,142 | mg/L |
| Carbonate | <1 | mg/L |
| Bicarbonate | 150 | mg/L |

### Example 8

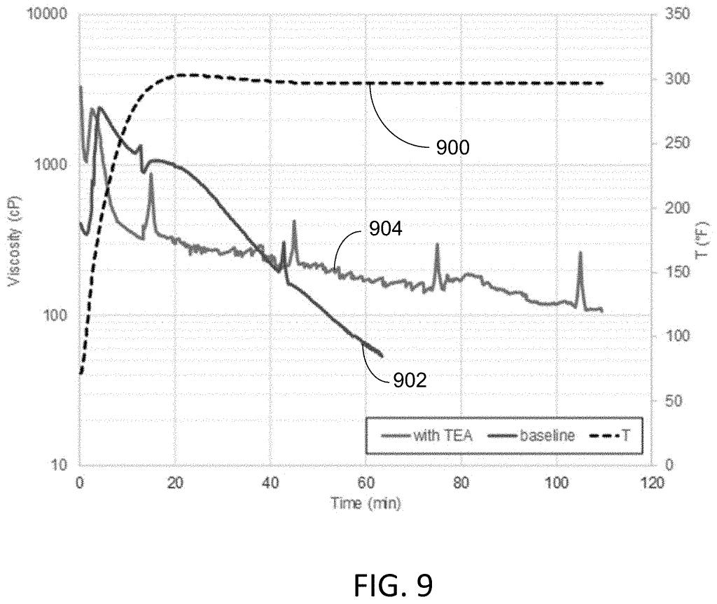

High-TDS produced water was used in this example. The composition of the high-TDS produced water is shown in Table 9. The high-TDS produced water had a TDS of 295,000 mg/L, a total hardness of 45,200 mg/L, and a pH of 6. The high-TDS was more than five times that of the seawater in Example 7. The produced water hardness was about 4.5 times that of the seawater in Example 7. Plot 900 in FIG. 9 shows the temperature (° F.) at which viscosity measurements were made. In FIG. 9, the viscosity was measured following the API RP 39 schedule. Comparative fracturing fluid CFF8 (“baseline”; no nanoparticle solution) was prepared with high-TDS produced water having the composition shown in Table 9, 60 ppt HPG, and 3 gpt TYZOR® 212 organic zirconate crosslinker, and had a pH between 6 and 7 at room temperature. Plot 902 shows the fluid viscosity of CFF8 versus time. The fluid viscosity of CFF8 stayed greater than 100 cP for less than 55 minutes at 300° F. Plot 904 shows the fluid viscosity of fracturing fluid FF8 (“with TEA”), which was prepared with the high-TDS produced water having the composition shown in Table 9, 60 ppt HPG, 3 gpt TYZOR 212 organic zirconate crosslinker, and 2.5 gpt triethanolamine (TEA), and had a pH between 6 and 7 at room temperature. Comparison of plots 902 and 904 shows that the TEA enhanced the fluid stability and viscosity of FF8 at 300° F. relative to that of CFF8, with the viscosity of FF8 staying above 100 cP for over almost 2 hours.

TABLE 9
Water analysis of the high-TDS produced water used in Example 8.

| Component | Concentration | |
|---|---|---|
| Boron | 280 | mg/L |
| Barium | 18 | mg/L |
| Calcium | 16100 | mg/L |
| Iron | <1 | mg/L |
| Magnesium | 1220 | mg/L |
| Potassium | 4960 | mg/L |
| Silicon | <1 | mg/L |
| Sodium | 91840 | mg/L |
| Strontium | 1170 | mg/L |
| Chloride | 178740 | mg/L |
| Sulfate | 403 | mg/L |
| Carbonate | <1 | mg/L |
| Bicarbonate | 128 | mg/L |
| TDS | 295000 | mg/L |
| Total Hardness | 45200 | mg/L |

| | |
|---|---|
| pH | 6 |

### Example 9

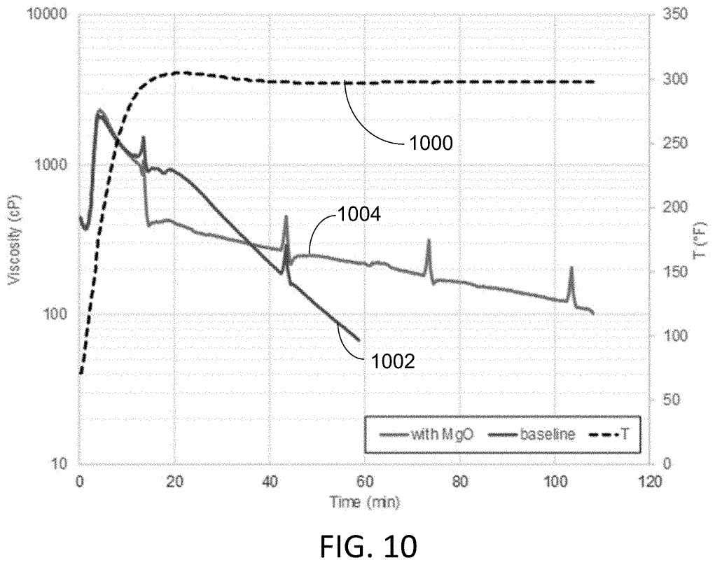

Comparative fracturing fluid CFF9 (“baseline”; plot 1002) was prepared with the high-TDS produced water of Example 8, 60 ppt HPG, and 3 gpt TYZOR 212 organic zirconate crosslinker, and had a pH between 6 and7 at room temperature. Plot 1000 in FIG. 10 shows the temperature (° F.) at which viscosity measurements were made. In FIG. 10, the viscosity was measured following the API RP 39 schedule. As shown in plot 1002, the fluid viscosity of CFF9 stayed greater than 100 cP for less than 55 minutes at 300° F. Fracturing fluid FF9 (“with MgO”; plot 1004) was prepared with the high-TDS produced water of Example 9, 60 ppt HPG, 3 gpt TYZOR 212 organic zirconate crosslinker, and 10 ppt of MgO powder, and had a pH between 6 and 7 at room temperature. Comparison of plots 1002 and 1004 shows that the MgO enhanced the fluid stability and viscosity of FF9 at 300° F. relative to that of CFF9, with the viscosity of FF9 staying above 100 cP for almost 2 hours.

A number of implementations have been described. Nevertheless, it will be understood that various modifications can be made without departing from the spirit and scope of the disclosure.

What is claimed is:

1. A fracturing fluid comprising:
an aqueous base fluid having total dissolved solids between 100,000 mg/L and 400,000 mg/L;
a polymer;
a crosslinker; and
at least one of a free amine and an alkaline earth oxide.

2. The fracturing fluid of claim 1, wherein the aqueous base fluid has total dissolved solids between 200,000 mg/L and 300,000 mg/L.

3. The fracturing fluid of claim 2, wherein the aqueous base fluid has total dissolved solids of about 300,000 mg/L.

4. The fracturing fluid of claim 1, wherein the alkaline earth oxide comprises at least one of calcium oxide and magnesium oxide.

5. The fracturing fluid of claim 1, wherein the fracturing fluid comprises from about 0.01% to about 20% by weight, from about 0.02% to about 10% by weight, or from about 0.04% to about 2% by weight of the alkaline earth oxide.

6. The fracturing fluid of claim 1, wherein the free amine comprises at least one of triethanolamine, N-methylethanolamine, dimethylethanolamine, diethylethanolamine, diethanolamine, N,N-diisopropylaminoethanol, methyldiethanolamine, bis-tris methane, ethylendiamine, diethylenetriamine, triethylenetetramine, tetraethylenepentamine, and pentaethylenehexamine.

7. The fracturing fluid of claim 1, wherein the fracturing fluid comprises from about 0.01% to about 20% by weight, from about 0.05% to about 5% by weight, or from about 0.1% to about 2% by weight of the free amine.

8. The fracturing fluid of claim 1, wherein the crosslinker comprises a Zr crosslinker, a Ti crosslinker, an Al crosslinker, a borate crosslinker, or a combination thereof.

9. The fracturing fluid of claim 1, wherein the fracturing fluid comprises from about 0.02% to about 2% by weight of the crosslinker.

10. The fracturing fluid of claim 1, further comprising a nanomaterial.

11. The fracturing fluid of claim 10, wherein the nanomaterial comprises ZrO₂ nanoparticles, TiO₂ nanoparticles, CeO₂ nanoparticles, or a combination thereof.

12. The fracturing fluid of claim 10, wherein the nanomaterial is stabilized with a polymer, a surfactant, or a combination thereof.

13. The fracturing fluid of claim 10, wherein the fracturing fluid comprises about 0.0002 wt. % to about 2 wt. % of the nanomaterial.

14. The fracturing fluid of claim 1, wherein the polymer comprises guar, hydroxypropyl guar, carboxymethyl hydroxypropyl guar, derivatized guar, carboxymethyl cellulose, carboxtmethyl hydroxyl propyl cellulose, cellulose derivatives, or a combination thereof.

15. The fracturing fluid of claim 1, further comprising a bactericide.

16. The fracturing fluid of claim 1, further comprising a buffer, wherein the buffer comprises bicarbonate, carbonate, acetate, or a combination thereof.

17. The fracturing fluid of claim 1, further comprising a stabilizer, wherein the stabilizer comprises sodium thiosulfate, sorbitol, alkylated sorbitol, or a combination thereof.

18. The fracturing fluid of claim 1, further comprising a viscosity breaker, wherein the viscosity breaker comprises an oxidative breaker.

19. The fracturing fluid of claim 1, further comprising a surfactant.

20. The fracturing fluid of claim 1, further comprising a scale inhibitor.
